(19) United States
(12) Patent Application Publication
(10) Pub. No.: US 2006/0161902 A1
(43) Pub. Date: Jul. 20, 2006

(54) System and method for modifying files defining a graphically displayed process

(75) Inventors: Guruprasad Srinivasamurthy, Cupertino, CA (US); Yue Fang, Mountain View, CA (US); Zhong Zhang, Los Altos, CA (US); Pavan Bayyapu, Sunnyvale, CA (US)

Correspondence Address: KENYON & KENYON LLP, 1500 K STREET N.W., SUITE 700, WASHINGTON, DC, 20005, US

(73) Assignee: SAP Aktiengesellschaft

(21) Appl. No.: 11/037,169

(22) Filed: Jan. 19, 2005

(51) Int. Cl. G06F 9/44

(52) U.S. Cl. 717/132

(57) ABSTRACT

A method and system automatically generate a flow diagram displaying a process flow between configuration files and application files in a predefined process. An indication of a location of the configuration files and the application files is received. Flow information is extracted from the configuration files and from the application files. The flow diagram displaying a process flow between the configuration files and the application files is then generated.

### COPYRIGHT NOTICE

A portion of the disclosure of this patent document contains material that is subject to copyright protection. The copyright owner has no objection to the facsimile reproduction by anyone of the patent document or patent disclosure as it appears in the Patent and Trademark Office patent file or records, but otherwise reserves all copyright rights whatsoever.

### BACKGROUND OF THE INVENTION

In today's complex software environment, information may be represented in a myriad of different formats, each of which define a particular arrangement of data that can be processed and/or stored by a computer. In some computing environments, it is desirable to represent information in a process or flow. Any particular computing process can be represented in a flow diagram for easier visual comprehension of the flow of the particular process. For example, a login process could be represented in a flow diagram such that the various steps of the process are easy to visualize.

Such processes are often configured within software in a computer in particular types of files. For example, the process may be configured within a series of configuration files. The files may also be configured in other types of files, such as application files, or in a combination of different types of files, such as in a combination of configuration and application files.

These types of files defining the flow of a particular process are often numerous, and can be difficult to work with, particularly for a user who is not an expert with such computer processes. Working with the flow of such a process can be very difficult when all one has to work with is such configuration and application files. Further, modifying such files can also be difficult, particularly for the non-expert user.

Accordingly, there is a need in the art for an improved system and method for taking such process files and automatically displaying such files in a flow diagram format that is easy to visualize and use. There is also a need to allow such displayed flow diagrams to be easily modified.

### BRIEF DESCRIPTION OF THE DRAWINGS

FIG. 1 is a flowchart illustrating a process in accordance with an embodiment of the present invention.

FIG. 2 is a flowchart illustrating a process in accordance with an embodiment of the present invention.

FIG. 3 is a screenshot of a flow diagram in accordance with an embodiment of the present invention.

FIG. 4 is a screenshot of a flow diagram in accordance with an embodiment of the present invention.

FIG. 5 is a block diagram that depicts a user computing device in accordance with an embodiment of the present invention.

FIG. 6 is a block diagram that depicts a network architecture in accordance with an embodiment of the present invention.

FIG. 7 is a flowchart illustrating a process in accordance with an embodiment of the present invention.

FIG. 8 is a screenshot of a flow diagram in accordance with an embodiment of the present invention.

FIG. 9 is a screenshot of a modified flow diagram in accordance with an embodiment of the present invention.

### DETAILED DESCRIPTION

Embodiments of the present invention implement a method and system that automatically updates configuration files and application files when a user modifies a flow diagram created from the configuration files and application files. The flow diagram may be modified by techniques such as dragging and dropping, for example.

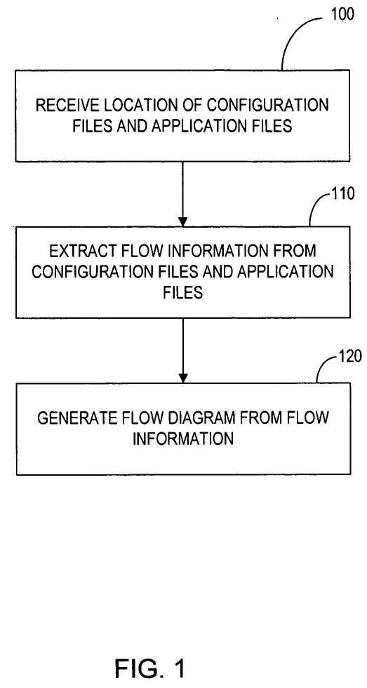

FIG. 1 depicts a process in accordance with an embodiment of the present invention. In step 100, an indication of a location of the configuration files and the application files is received. As further explained below, this indication may be input by a user that wants to automatically generate a flow diagram of the process flow between configuration files and application files for a process that has been predefined.

In step 110, flow information is extracted from the configuration files and from the application files. Details of the extraction of the flow information from the configuration files and application files are further discussed below. The flow information is information contained in the configuration files and in the application files that indicates one or more destination nodes from the configuration or application file and/or a flow label. The flow information may include flow labels and/or flow destinations.

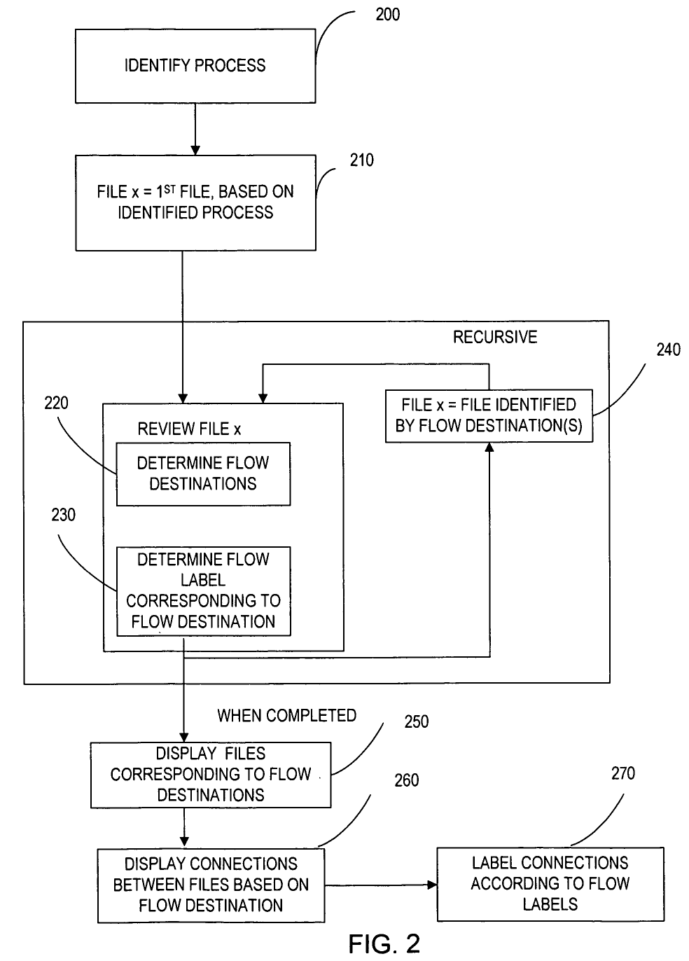

In step 120, the flow diagram displaying a process flow between the configuration files and the application files is then generated from the flow information. The generated flow diagram and the method used to generate it are further explained below in conjunction with FIG. 2.

FIG. 2 illustrates a process in accordance with an embodiment of the present invention. In step 200, a process is identified by receipt of the indication of the location of the file or by other means. Each process my have one or a plurality of configuration or application files associated with it. For each file x, the present invention may process the files to determine flow destinations and/or flow labels.

In step 210, a first file in the process is identified. The flow destination for the file is determined in step 220, and the flow label (if any) is determined in step 230, as further described below. In 240, the flow destination may be used to identify additional files, and steps 220 and 230 of determining the additional flow destinations and/or flow labels will continue until all destinations and labels in the process are determined.

When all of the flow destinations and/or flow labels are determined, the files may be displayed along with the corresponding flow destinations in step 250. In step 260, the connections between the files may be displayed based on the determined flow destinations. In step 270, the connections may be labeled according to the flow labels. These steps are further illustrated below.

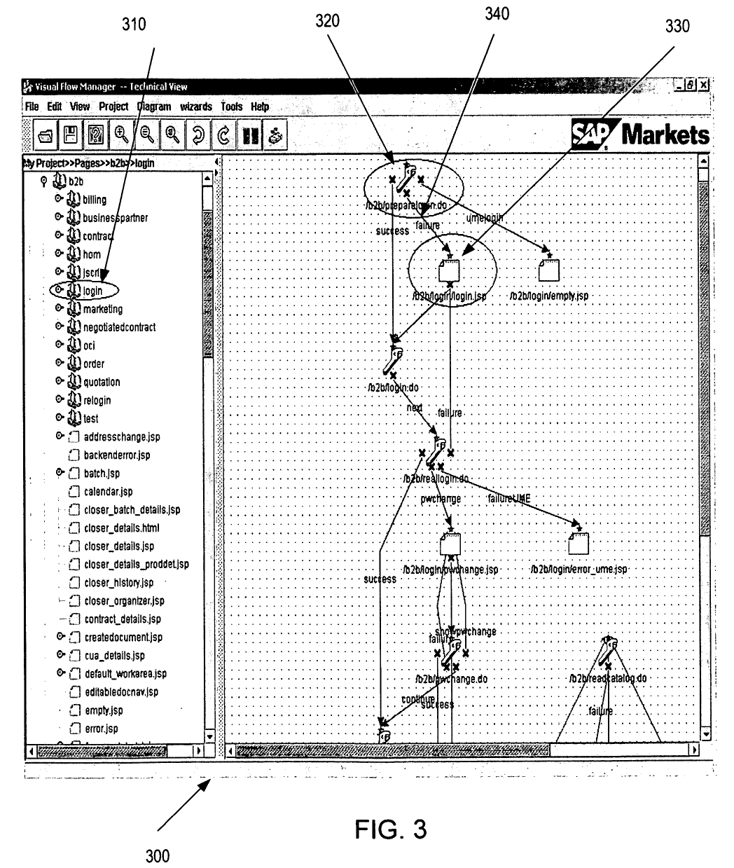

FIG. 3 illustrates a flow diagram 300 that has been generated in accordance with an embodiment of the present invention. The flow diagram 300 has been generated in accordance with a predefined login process that includes application files and configuration files. The flow diagram 300 that is illustrated in FIG. 3 is a flow of a login process 310. The flow diagram 300 illustrates configuration files, application files, and the flow of the process between them. In the flow diagram 300, spanner wrench icons are used to represent configuration files and document icons are used to represent application files, although any type of icon may be used. A configuration file is represented in the flow diagram by the spanner wrench 320 labeled “/b2b/preparelogin.do”. This icon could correspond to the following configuration entries in config.xml:

```
<action path=“/b2b/preparelogin”
type=“com.sapmarkets.isa.isacore.action.b2b.PrepareLoginAction”>
      <forward name=“success” path=“/b2b/login.do”/>
      <forward name=“umelogin” path=“/b2b/login/empty.jsp”/>
      <forward name=“failure” path=“/b2b/login/login.jsp”/>
</action>
```

Flow labels and flow destinations are information that may be extracted from the configuration file for use in generating the flow diagram in accordance with embodiments of the present invention. In the particular example shown above, three labels, “success”, “failure” and “umelogin” are extracted from the configuration file. Also, three corresponding flow destinations are extracted, namely “/b2b/login.do”, “/b2b/login/empty.jsp” and “/b2b/login/login.jsp”. The flow label 340 illustrated in FIG. 3 is labeled “failure”. The flow destination 330 is labeled “/b2b/login/login.jsp”. The flow labels and flow destinations are useful for a user in visualizing the flow of the process.

The flow destination 330 “/b2b/login/login.jsp” is an application file, which in this case is a .jsp file. Other types of application files could also be used, such as HTML (Hyper-Text Markup Language) files. The application files also have flow information extracted from them as described above. The “/b2b/login/login.jsp” application file may include:

<form method=“POST” action=‘<isa:webappsURL
name=“b2b/login.do”/>’ name=“login_form”
onSubmit=“return checkFields( )”>

This application file is tokenized to extract the flow destination. This is accomplished by breaking the .jsp file from a long character stream into small parts (tokens), from which the flow destination and any flow labels may be extracted. For example, this may be accomplished by breaking the web page file from a long character stream into a series of small meaningful parts (tokens), so it is easy to operate on. In the example, the following line from a application file may be broken into a series of tokens:
<form action=‘<isa:webappsURL name=“b2b/login.do”/>’name=“loginForm”>
may be broken into [“form”, “action”, “isa:webappsURL”, “name”, “b2b/login.do”, “name”, “loginForm”]. This may be done by using Java's (or some other language's) string operation library. Then the flow destinations can be extracted from those tokens. To achieve this, a coding standard may be used, such as SAP Internet Sales application's web page source file, where all the links are encapsulated by a specific tag (a common approach among business level internet applications). Other coding standards could also be used. The tokens are searched for that correspond to that specific tag, for example, the “isa:webappsURL” token, and then the following token is extracted as the flow destination. In this case, the flow destination “b2b/login.do” is extracted for use in creating the flow diagram. This particular destination does not include a label, but in examples where a label is used, the label is also extracted.

The flow information may be extracted from the configuration files by known techniques. For example, a standard XML package may be used for extraction, such as DOM (Document Object Model) or SAX (Simple API for XML) which are widely available and known. These XML packages may be used to parse the flow information from the files.

The present invention may use any number of application files and configuration files to generate a flow diagram, depending upon the complexity of the process. The application files may be of various types other than the .jsp files illustrated herein. The present invention may be used with a system having stored therein a large number of such processes that each can be used to generate such a flow diagram in accordance with the embodiment. For example, in addition to the “login” process 310 illustrated in FIG. 1, other processes are illustrated such as “billing”, “businesspartner”, etc. Each of these processes could be used to generate a flow diagram in accordance with embodiment of the invention.

Embodiments of the invention may be used with a plurality of processes, to generate a plurality of flow diagrams. The plurality of processes may be related, and even grouped together, such as, for example, in a common group or project.

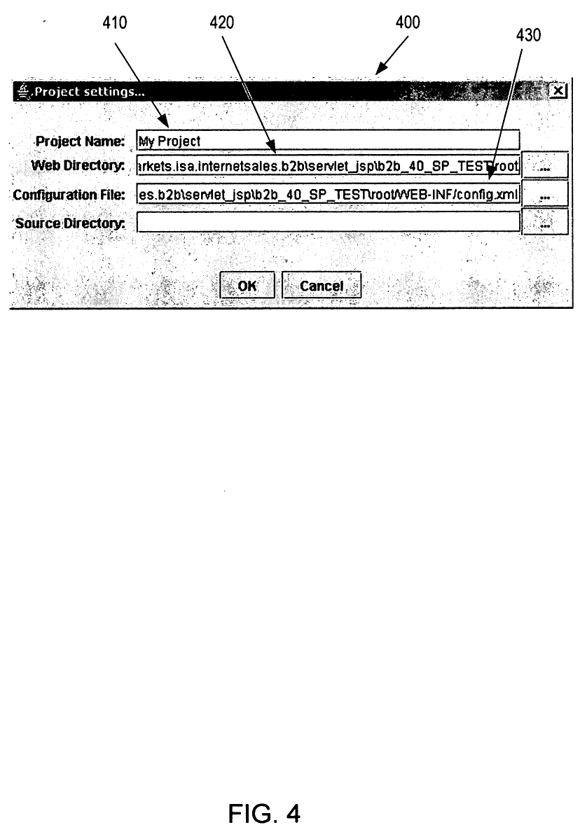

FIG. 4 illustrates a screen shot 400 that may be used in accordance with the present invention. The screen shot 400 includes a project name 410, an application file location 420 and a configuration file location 430. The screen shot 400 is generated to prompt a user to enter the location of application files and configuration files that the present invention will use to extract the flow information used to generate the flow diagram or diagrams. Alternatively, the screenshot 400 could be used to only require entry of the project name, and the location of the configuration files and application files could automatically be generated.

Embodiments of the present invention extract the flow destinations and flow labels for each configuration file and application file, and creates the flow diagram by generating an icon for the destinations, with arrows between each destination indicating the flow. The flow labels are associated with the corresponding arrow to show a result that will cause the process to move to a particular destination. Any type of icon or symbol may be used, and the icons shown herein are only ones of many possible examples that could be used. The flow diagrams may be rendered and displayed on a screen in any of many methods known to those of skill in the art.

The screenshot 400 is shown with the project name “My Project.” As may be seen with reference to FIG. 2, the project “My Project” not only includes the “login” process, but also includes the various other processes such as “billing”, “businesspartner”, etc. Embodiments of the present invention can be used to simultaneously generate a plurality of flow diagrams for a plurality of processes within a project, or can be used to generate one or more flow diagrams for a single process. If a project includes a plurality of processes and it is desired to generate the flow diagrams for all of the processes, embodiments of the present invention will do so by receiving the location of the configuration files and application files, and extracting the flow information for each process. The extracted flow information is then associated with the corresponding process, so that the separate flow diagrams may be formed. If the flow information is not associated with a particular process, when a user wants to display the flow diagram for a process, any flows related to it may be dynamically formed.

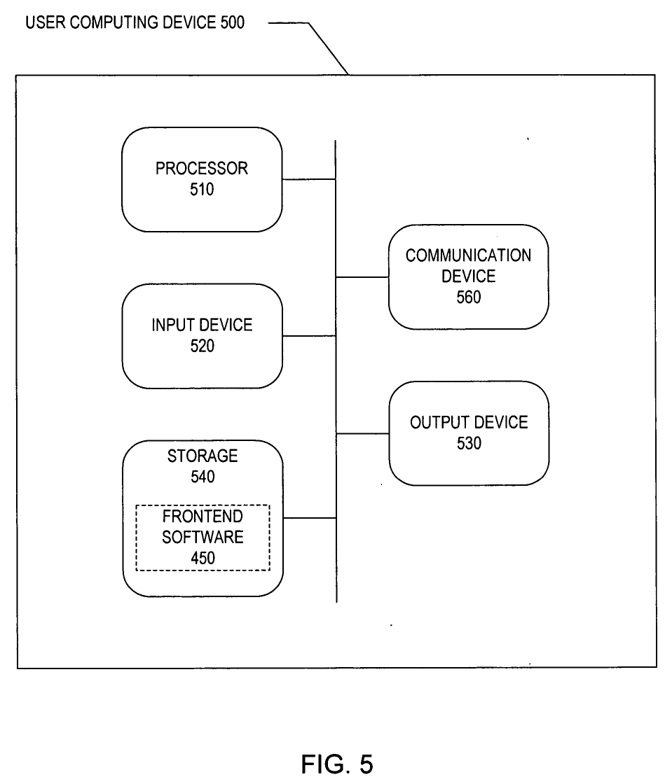

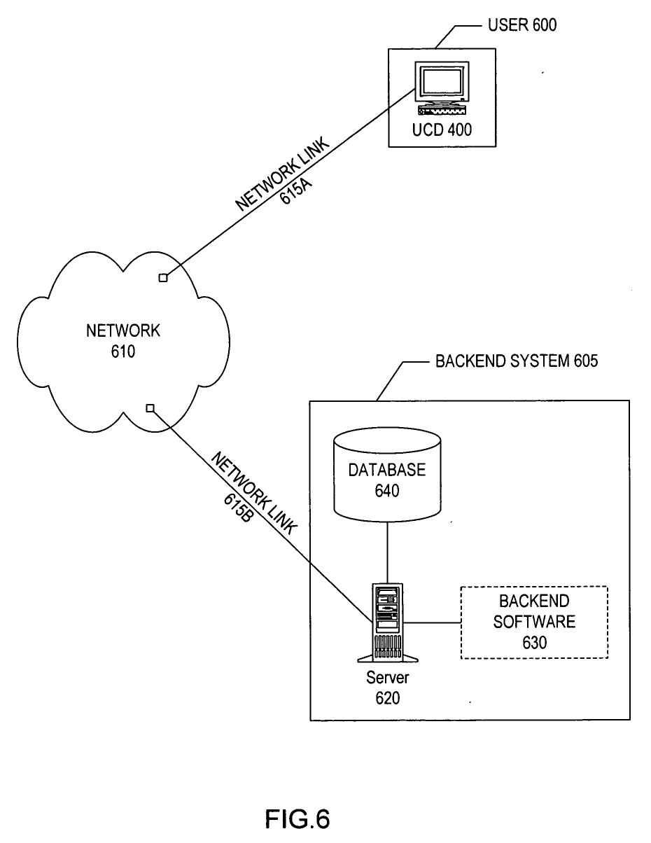

FIGS. 5 and 6 illustrate the components of a basic computer and network architecture in accordance with an embodiment of the present invention. Embodiments of the present invention may not need all of the elements described herein. FIG. 5 depicts user computing device 500, which may be a personal computer, workstation, handheld personal digital assistant (“PDA”), or any other type of microprocessor-based device. User computing device 400 may include one or more of processor 510, input device 520, output device 530, storage 540, and communication device 560.

Input device 520 may include a keyboard, mouse, pen-operated touch screen or monitor, voice-recognition device, or any other device that provides input. Output device 530 may include a monitor, printer, disk drive, speakers, or any other device that provides output.

Storage 540 may include volatile and nonvolatile data storage, including one or more electrical, magnetic or optical memories such as a RAM, cache, hard drive, CD-ROM drive, tape drive or removable storage disk. Communication device 560 may include a modem, network interface card, or any other device capable of transmitting and receiving signals over a network. The components of user computing device 500 may be connected via an electrical bus or wirelessly.

Software 550, which may be stored in storage 540 and executed by processor 510, may include, for example, the client side of a client/server application that embodies the functionality of the present invention (e.g., automatically generating the flow diagrams). Thus software for executing the above-described functionality may be placed in storage 540 and executed by processor 510 to automatically generate the flow diagrams.

FIG. 6 illustrates a network architecture that could be used in accordance with an embodiment of the present invention. According to one particular embodiment, when user 600 invokes a client/server application hosted by Enterprise System 605, client software 650 of user computing device 600 communicates with server software 630 (e.g., the server side of the client/server application) of server 620 via network link 615a, network 610, and network link 615b. The server software 630 may perform the functionality of the present invention, where a user connects to the backend system via network 610, for example. In this embodiment, the flow diagrams could be generated in Server 620, and displayed at UDC 500.

Network links 615 may include telephone lines, DSL, cable networks, T1 or T3 lines, wireless network connections, or any other arrangement that implements the transmission and reception of network signals. Network 610 may include any type of interconnected communication system, which may implement any communications protocol, which may be secured by any security protocol.

Server 620 includes a processor and memory for executing program instructions as well as a network interface, and may include a collection of servers. In one particular embodiment, server 620 may include a combination of enterprise servers such as an application server and a database server. Database 640 may represent a relational or object database, and may be accessed via a database server.

User computing device 500 and server 620 may implement any operating system, such as Windows or UNIX. Client software 650 and server software 630 may be written in any programming language, such as ABAP, C, C++, Java or Visual Basic.

In other embodiments, application software embodying the functionality of the present invention may be deployed on a standalone machine or through a Web browser as a Web-based application or Web service, for example.

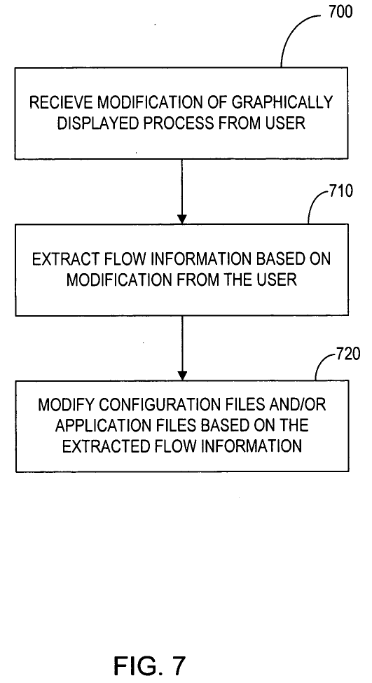

FIG. 7 depicts a process in accordance with an embodiment of the present invention. In step 700, a modification of a graphically displayed process is received from the user. The modification may be made by the user using an input device, such as input device 520, for example. The modification may be made by the user using one of many known methods. For example, the modification may be made by the user using a technique such as “dragging and dropping” an element in the graphically displayed process, as will be described below. The user could also indicate a modification by other methods such as by typing in a modification on a keyboard or other input device.

In step 710, flow information is extracted based on the modification received from the user. This flow information may include a starting and/or end point of an element or elements in the flow process, and any labels that may be associated with the element, as further explained below. The flow information is then used to modify the configuration files and/or the application files that define the displayed process.

In step 720, the application files and/or configuration files that define the graphically displayed process are modified based on the extracted flow information. The modifications may happen automatically in response to the user making a modification to the graphically displayed process, or the modifications could happen in response to user direction. In the latter case, the modifications could happen in response to the user giving an indication to modify the files. For example, the user could be provided with a graphically displayed indication to “save changes”, although any such indication would work with embodiments of the present invention.

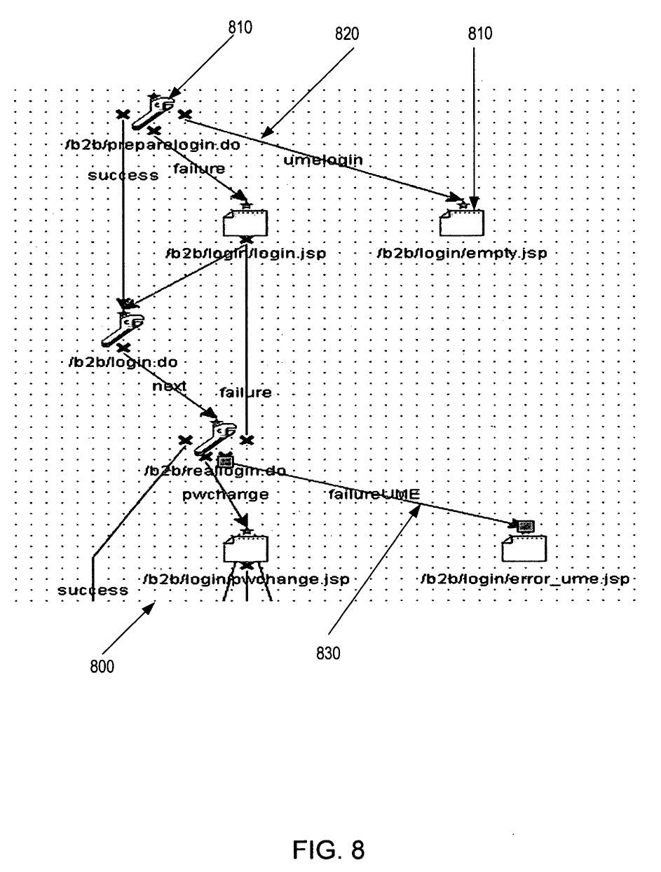

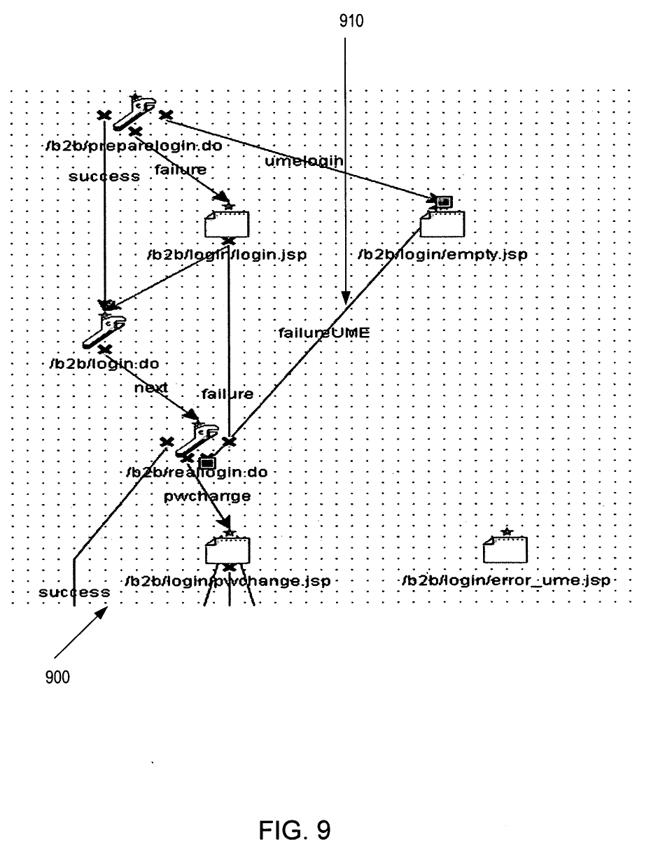

FIGS. 8 and 9 illustrate a flow process before and after modification by a user. In FIG. 8 a portion of a flow diagram is illustrated in accordance with embodiments of the present invention. The flow diagram includes flow destinations 810, with arrows 830 between them representing the flow. The arrows may include a label that could be used to present context to the flow, such as “success”, “failure”, “failure UME”, etc. Embodiments of the present invention allow a user to modify the flow diagram and the associated configuration files and/or application files in a manner that is intuitive and easy to use, as further explained below.

In an illustrative example, a user desires to modify the flow diagram 800 and the associated configuration files and/or application files. In the example illustrated herein, the present invention allows the user to drag the head of the arrow labelled “failureUME” from the destination “/b2b/login/error_ume.jsp” to the destination “/b2b/login/empty.jsp”. This could be accomplished by right clicking on the end of the arrow at the point that is desired to be moved, and dragging the arrow head to a new destination, although any method of indicating a desired change could be used.

As shown in the modified flow diagram of FIG. 9, embodiments of the present invention allow the user to modify the flow diagram in an easy to use and intuitive manner. By dragging and dropping the arrow as described above, the arrow 910 is now moved to the destination “/b2b/login/empty.jsp”, along with the label “failureUME”. As further described below, embodiments of the present invention will update the corresponding configuration files and/or application files. This could be done automatically, or upon user direction to update the files. The change to the flow diagram is determined by extracting the flow information that has changed, such as a new flow start or flow destination, or a new label, and the corresponding files are updated.

For example, in the example illustrated in FIGS. 8 and 9, in the config.xml file, the configuration file is changed accordingly from:

```
    <action path=“/b2b/reallogin” input=“/b2b/login/login.jsp”
    type=“com.sapmarkets.isa.isacore.action.b2b.LoginAction”>
      <forward name=“sucess” path=“/b2b/shoplist.do”/>
      <forward name=“failure” path=“/b2b/login/login.jsp”/>
      <forward name=“pwchange” path=“/b2b/login/pwchange.jsp”/>
      <forward name=“failureUME” path=“/b2b/login/error_ume.jsp”/>
    </action>
to:
    <action path=“/b2b/reallogin” input=“/b2b/login/login.jsp”
    type=“com.sapmarkets.isa.isacore.action.b2b.LoginAction”>
      <forward name=“success” path=“/b2b/shoplist.do”/>
      <forward name=“failure” path=“/b2b/login/login.jsp”/>
      <forward name=“pwchange” path=“/b2b/login/pwchange.jsp”/>
      <forward name=“failureUME” path=“/b2b/login/empty.jsp”/>
    </action>
```

Embodiments of the present invention will likewise modify application files, such as .jsp files, based on a user modifying the flow diagram. The present invention thus avoids the user having to manually edit the configuration files and/or the application files, and instead updates these files for the user. The user will not need to open the file in text editor, and there will be no mis-typing that could create problems when manual editing is performed. Further, a user who may not be experienced with configuration and application files can easily update the involved process using embodiments of the present invention.

As described above, flow information is extracted from the configuration files and application files to be used in generating the graphically displayed flow process. The flow information may include start and destination nodes, as well as labels associated with a process flow between nodes. When the user modifies the graphically displayed process, embodiments of the present invention will modify the configuration files and/or the application files.

Information corresponding to a particular node may be stored in a configuration file or in an application file. As described above, the configuration files may be XML files that may be parsed to extract the flow information. When a user modifies the graphically displayed process, any new flow information, such as a new flow start node, destination node or label, may be captured and used to update the corresponding configuration file. Alternatively, an entire new configuration file could be generated from the modified flow, and sent to replace the previous configuration file.

As further described above, the application files may be .jsp files. In this case, as described above, the application files are tokenized to extract the flow information, which may include start and destination nodes, or labels. When the user modifies the graphically displayed process, embodiments of the present invention capture the new flow information. This new flow information is then used to replace the corresponding tokens in the corresponding application file. Alternatively, a new application file could be generated to replace the existing application file.

Several embodiments of the invention are specifically illustrated and/or described herein. However, it will be appreciated that modifications and variations of the invention are covered by the above teachings and within the purview of the appended claims without departing from the spirit and intended scope of the invention.

What is claimed is:

1. A computer-implemented method for automatically modifying configuration files and/or application files defining a graphically displayed process, comprising:
receiving a modification to the graphically displayed process from a user;
extracting flow information based on the modification from the user; and
automatically modifying the configuration files and/or the application files based on the extracted flow information.

2. The method of claim 1, wherein the flow information includes a flow label and/or a flow destination.

3. The method of claim 1, wherein automatically modifying the configuration files and/or the application files based on the extracted flow information comprises modifying the configuration files and/or the application files without user direction to do so.

4. The method of claim 1, wherein the modification to the graphically displayed process includes a user dragging and dropping an element on the graphically displayed process.

5. The method of claim 4, wherein the element includes a graphical representation of a process flow between a flow start point and a flow destination point.

6. The method of claim 1, wherein extracting the flow information comprises determining a flow start point and/or a flow destination point of the modification to the graphically displayed process from the user.

7. The method of claim 6, wherein automatically modifying the configuration files and/or the application files based on the extracted flow information comprises modifying the configuration files and/or the application files based on the extracted flow start point and/or a flow destination point of the modification to the graphically displayed process from the user.

8. The method of claim 7, wherein automatically modifying the configuration files and/or the application files based on the extracted flow information further comprises determining flow start points and flow destination points of the configuration files and/or application files defining the graphically displayed process before the user modification, and modifying the flow start points and flow destination points of the configuration files and/or application based on the extracted flow start point and/or a flow destination point of the modification to the graphically displayed process from the user.

9. The method of claim 1, wherein the configuration files are .jsp (Java Server Pages) files.

10. An apparatus for automatically modifying configuration files and/or application files defining a graphically displayed process, comprising:
a processor; and
a memory coupled to the processor, the memory storing instructions adapted to be executed by the processor to:
receive a modification to the graphically displayed process from a user;
extract flow information based on the modification from the user; and
automatically modifying the configuration files and/or the application files based on the extracted flow information.

11. The apparatus of claim 10, wherein the flow information includes a flow label and/or a flow destination.

12. The apparatus of claim 10, wherein the instructions to automatically modifying the configuration files and/or the application files based on the extracted flow information comprise instructions to modify the configuration files and/or the application files without user direction to do so.

13. The apparatus of claim 10, wherein the modification to the graphically displayed process includes a user dragging and dropping an element on the graphically displayed process.

14. The apparatus of claim 13, wherein the element includes a graphical representation of a process flow between a flow start point and a flow destination point.

15. The apparatus of claim 10, wherein the instructions to extract the flow information comprise instructions to determine a flow start point and/or a flow destination point of the modification to the graphically displayed process from the user.

16. The apparatus of claim 15, wherein the instructions to automatically modify the configuration files and/or the application files based on the extracted flow information comprise instructions to modify the configuration files and/or the application files based on the extracted flow start point and/or a flow destination point of the modification to the graphically displayed process from the user.

17. The apparatus of claim 16, wherein the instructions to automatically modify the configuration files and/or the application files based on the extracted flow information further comprises instructions to determine flow start points and flow destination points of the configuration files and/or application files defining the graphically displayed process before the user modification, and modify the flow start points and flow destination points of the configuration files and/or application based on the extracted flow start point and/or a flow destination point of the modification to the graphically displayed process from the user.

18. The apparatus of claim 10, wherein the configuration files are .jsp (Java Server Pages) files.

19. A machine-readable medium having stored thereon a plurality of executable instructions, the plurality of instructions comprising instructions to:
receive a modification to the graphically displayed process from a user; extract flow information based on the modification from the user; and automatically modifying the configuration files and/or the application files based on the extracted flow information.
